(19) United States
(12) Patent Application Publication
(10) Pub. No.: US 2014/0300821 A1
(43) Pub. Date: Oct. 9, 2014

(54) ATSC Terrestrial TV Antenna Network

(71) Applicant: Lin Yang, Milpitas, CA (US)

(72) Inventor: Lin Yang, Milpitas, CA (US)

(21) Appl. No.: 13/892,504

(22) Filed: May 13, 2013

Related U.S. Application Data
(60) Provisional application No. 61/809,270, filed on Apr. 5, 2013.

(51) Int. Cl. H04N 5/38

(52) U.S. Cl. CPC H04N 5/38
USPC 348/723

(57) ABSTRACT

This invention is the means to build an ATSC Terrestrial TV Antenna Network. This network comprises of a TV transmitter antenna, a Wi-Fi TV antenna cluster, and an ATSC Terrestrial TV Antenna Network Management Unit.

This application claims the benefit of the U.S. Provisional application No. 61/809,270, filed Apr. 5, 2013.

### TECHNICAL FIELD

The present invention relates generally to terrestrial TV broadcasting.

### BACKGROUND

In the existing terrestrial ATSC HDTV broadcasting system, a TV Transmitter antenna transmits an RF signal which carries TV programming to millions of conventional TV receiving antennas. Each conventional TV antenna uses an antenna cable to connect to the conventional TV console. Each antenna is independent of other antennas.

The following patents are herein incorporated by reference: U.S. patent application Ser. No. 13/871,869 entitled WI-FI ATSC TV ANTENNA, by Yang; U.S. patent application Ser. No. 13/872,917 entitled MULTIPLE ANTENNA ATSC HDTV RECEIVER DEVICE, by Yang.

The present invention is a network system comprised of the above-referenced patents and controlled by a newly-invented management unit.

### SUMMARY OF INVENTION

This invention is an ATSC terrestrial TV antenna network comprising of a TV transmitter antenna, a Wi-Fi TV antenna cluster, and an ATSC Terrestrial TV Antenna Network Management Unit.

### BRIEF DESCRIPTION OF DRAWINGS

Having thus described the invention in general terms, reference will now be made to the accompanying drawings, which are not necessarily drawn to scale, and wherein:

FIG. 1 shows the existing terrestrial ATSC HDTV broadcasting system.

FIG. 2 shows an example of the ATSC Terrestrial TV Antenna Network for the home.

FIG. 3 shows an example of the ATSC Terrestrial TV Antenna Network for the car.

FIG. 4 shows an example of the ATSC Terrestrial TV Antenna Network for anywhere outside the home.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

### COMPONENT LIST

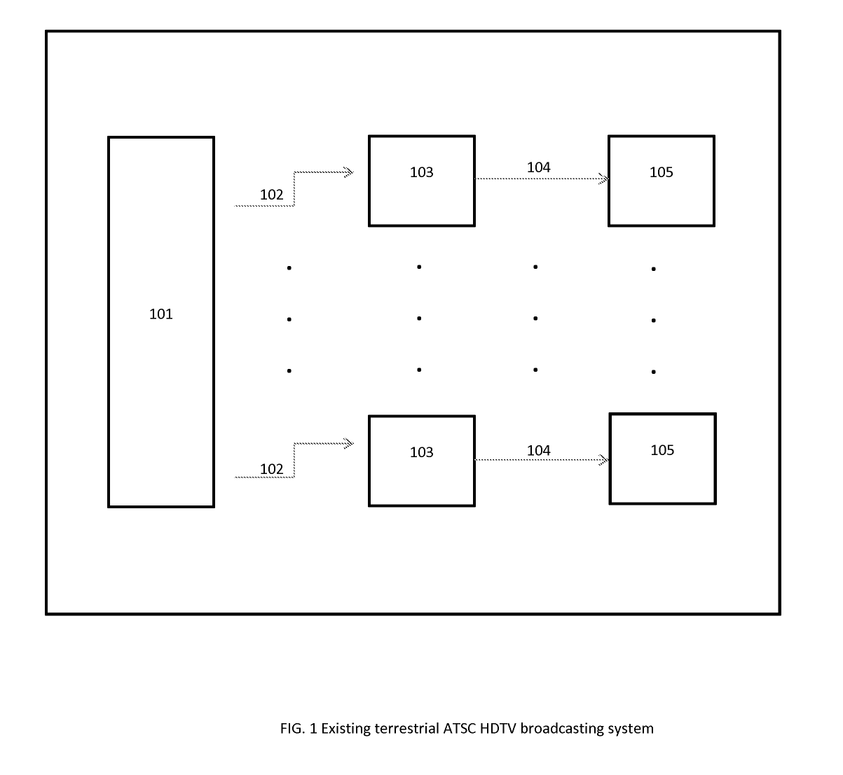

FIG. 1
100—Existing TV Broadcasting System
101—TV Transmitter Antenna
102—Transmitted RF Signal which carries the TV programming
103—Conventional TV receiving antenna (roof top, rabbit ear, powered antenna, etc.)
104—Antenna Cable
105—Conventional TV Console

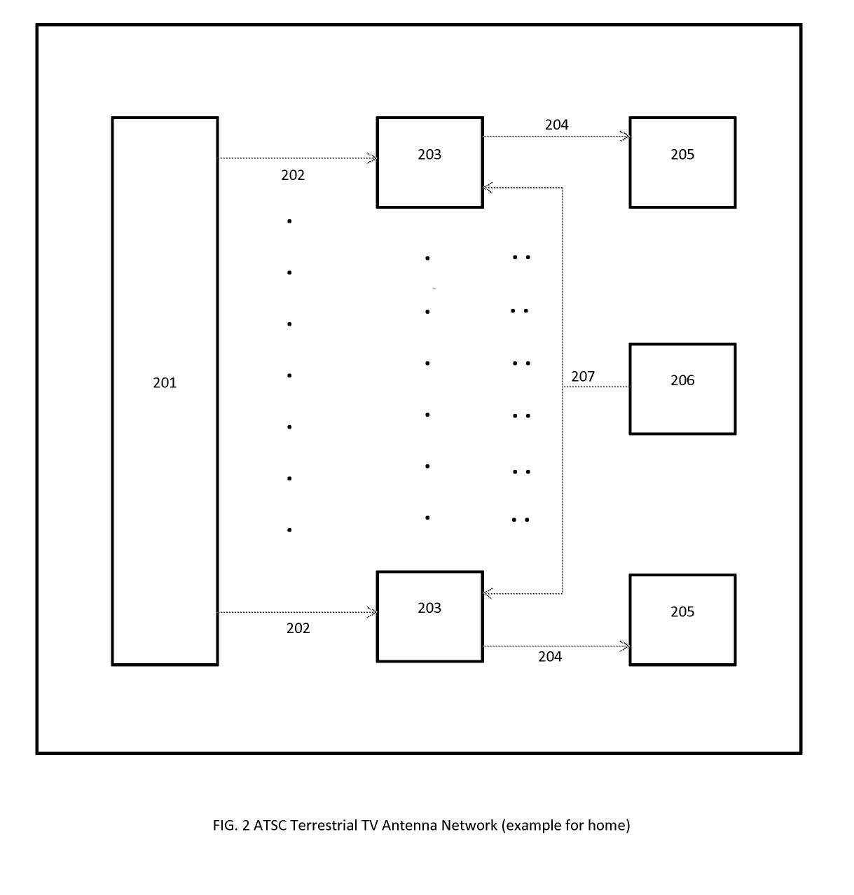

FIG. 2
200—ATSC Terrestrial TV Antenna Network (example for home)
201—TV Transmitter Antenna
202—Transmitted RF Signal which carries the TV programming
203—Wi-Fi TV Antenna Cluster (one or more Wi-Fi TV Antennas)
204—Wi-Fi Connection
205—TV Receiver Cluster (e.g. TV, laptop, tablet, cell phone, smart glasses, etc.)
206—ATSC Terrestrial TV Antenna Network Management Unit
207—Control Signal between the ATSC Terrestrial TV Antenna Network Management Unit and the Wi-Fi TV Antenna Cluster

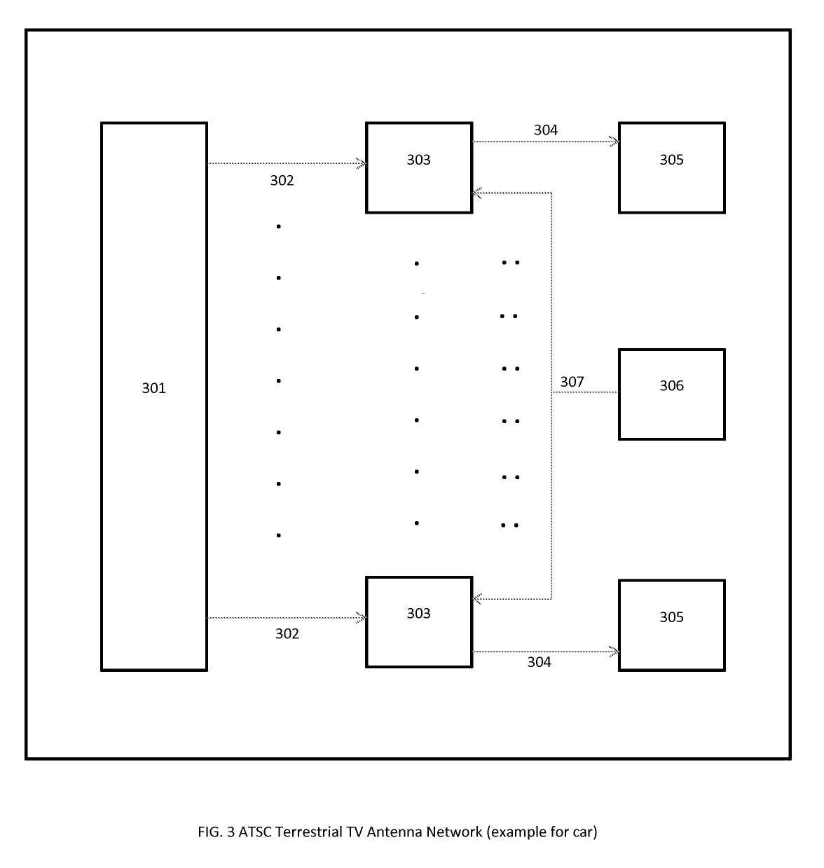

FIG. 3
300—ATSC Terrestrial TV Antenna Network (example for car)
301—TV Transmitter Antenna
302—Transmitted RF Signal which carries the TV programming
303—Wi-Fi TV Antenna Cluster (one or more Wi-Fi TV Antennas) in a car
304—Wi-Fi Connection
305—Car Infotainment System or personal TV viewing device (e.g. tablet, laptop, cell phone, portable game system, smart glasses, etc.)
306—ATSC Terrestrial TV Antenna Network Management Unit
307—Wireless Control Signal between the ATSC Terrestrial TV Antenna Network Management Unit and the Wi-Fi TV Antenna in a car

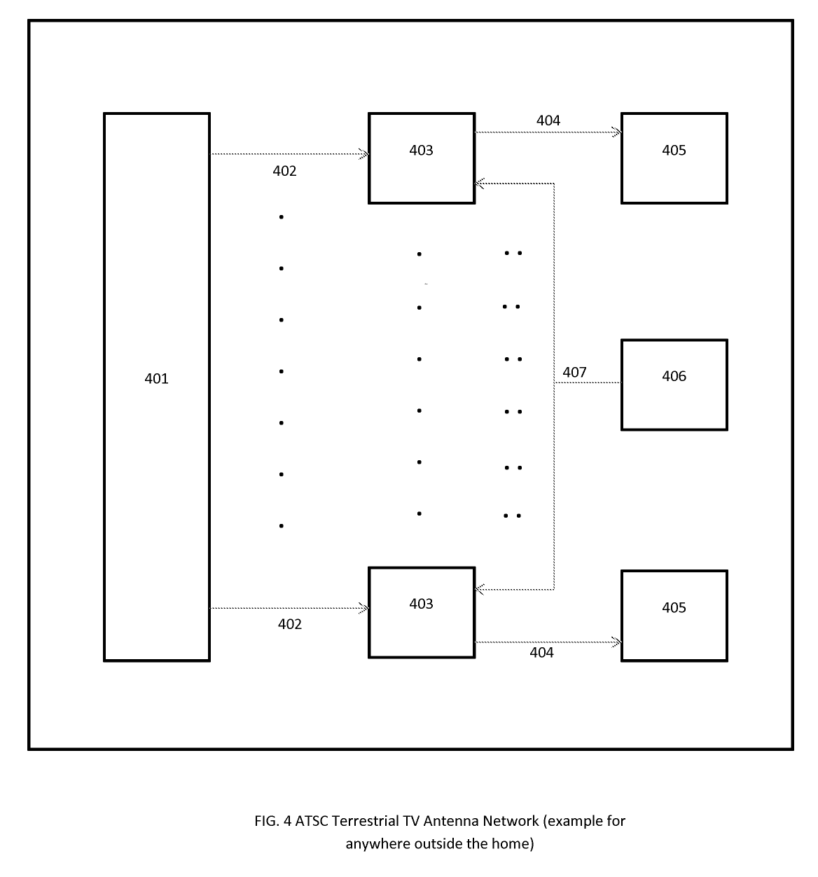

FIG. 4
400—ATSC Terrestrial TV Antenna Network (example for anywhere outside the home)
401—TV Transmitter Antenna
402—Transmitted RF Signal which carries the TV programming
403—Wi-Fi TV Antenna Cluster (one or more Wi-Fi TV Antennas)
404—Wi-Fi Connection
405—TV Receiver Cluster (e.g. TV, laptop, tablet, cell phone, smart glasses, etc.)
406—ATSC Terrestrial TV Antenna Network Management Unit
407—Control Signal between the ATSC Terrestrial TV Antenna Network Management Unit and the Wi-Fi TV Antenna Cluster

FIG. 1 shows the existing terrestrial ATSC HDTV broadcasting system (100).

A TV Transmitter antenna (101) transmits an RF signal (102) which carries TV programming to millions of conventional TV receiving antennas (103). Each conventional TV antenna (103) uses an antenna cable (104) to connect to the conventional TV console (105).

FIG. 2 is an example of the newly invented network. In this example, the TV Transmitter Antenna (201) and the Transmitted RF Signal which carries the TV programming (202) have the same function as the conventional system. Instead of using a single antenna for a conventional TV console, a Wi-Fi TV Antenna Cluster (203) is used.

The Wi-Fi Connection (204) between the TV receiver cluster (205) and the Wi-Fi TV Antenna Cluster (203) is authorized by the ATSC Terrestrial TV Antenna Network Management Unit (206) thru the control signal (207) between the ATSC Terrestrial TV Antenna Network Management Unit and the Wi-Fi TV Antenna Cluster. The control signal (207) can be carried by a dedicated network, telecom network, wireless communication network, or the internet.

FIG. 3 is another example of the newly invented network for ATSC Terrestrial TV viewing on car infotainment systems and mobile devices. In this example, the TV Transmitter Antenna (301) and the Transmitted RF Signal which carries the TV programming (302) have the same function as the conventional system. Instead of using a single antenna for a conventional TV console, a Wi-Fi TV Antenna Cluster (303) is used.

The Wi-Fi Connection (304) between the Car Infotainment System or personal TV viewing device (305) and the Wi-Fi TV Antenna Cluster (one or more Wi-Fi TV Antennas) in a car (303) is authorized by the ATSC Terrestrial TV Antenna Network Management Unit (306) thru the Wireless Control Signal (307) between the ATSC Terrestrial TV Antenna Network Management Unit and the Wi-Fi TV Antenna in a car. The control signal (307) can be carried by wireless communication network, or wireless internet.

FIG. 4 is another example of the newly invented network for ATSC Terrestrial TV viewing outside the home (e.g. restaurants, libraries, buses, airports, supermarkets, etc.). In this example, the TV Transmitter Antenna (401) and the Transmitted RF Signal which carries the TV programming (402) have the same function as the conventional system. Instead of using a single antenna for a conventional TV console, a Wi-Fi TV Antenna Cluster (403) is used.

The Wi-Fi Connection (404) between the TV receiver cluster (405) and the Wi-Fi TV Antenna Cluster (403) is authorized by the ATSC Terrestrial TV Antenna Network Management Unit (406) thru the control signal (407) between the ATSC Terrestrial TV Antenna Network Management Unit and the Wi-Fi TV Antenna Cluster. The control signal (407) can be carried by a dedicated network, telecom network, wireless communication network, or the internet.

What is claimed is:

1. An ATSC terrestrial TV antenna network comprising of:
a. A TV transmitter antenna,
b. A Wi-Fi TV antenna cluster, and
c. An ATSC Terrestrial TV Antenna Network Management Unit.

2. Control signals between (b) and (c) of claim 1 carried by a dedicated network, or telecom network, or wireless communication network, or the internet.

3. A system of claim 1 using the legacy ATSC terrestrial TV standard.

4. A system of claim 1 using the mobile ATSC terrestrial TV standard.

5. A system of claim 1 using the future ATSC terrestrial TV standard.

6. A system of claim 1 using a non-ATSC terrestrial TV standard.
